(19) United States
(12) Patent Application Publication
(10) Pub. No.: US 2010/0043032 A1
(43) Pub. Date: Feb. 18, 2010

(54) Electronic Device for Supporting Multimedia Over Coax Alliance Standard

(75) Inventors: Wei-Chun Tsao, Taipei City (TW); Chien-Ru Lin, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: UNIHAN CORPORATION, Taipei City (TW)

(21) Appl. No.: 12/536,563

(22) Filed: Aug. 6, 2009

(30) Foreign Application Priority Data
Aug. 12, 2008 (TW) 097130657

(51) Int. Cl. H04N 7/18; H04N 5/50

(52) U.S. Cl. 725/85; 725/78; 348/731; 348/E05.097

(57) ABSTRACT

The invention discloses an electronic device for supporting a multimedia over coax alliance (MoCA) standard. The electronic device is coupled with a coaxial cable. The electronic device includes an input terminal, a back stage processing unit, and a band pass filter. The input terminal is coupled with the coaxial cable. The band pass filter is coupled between the input terminal and the back stage processing unit, and it receives an input signal from the input terminal. The band pass filter allows a plurality of television channel signals in a predetermined frequency range to pass through and transmits them to the back stage processing unit to be processed. The band pass filter rejects a MoCA standard system signal to prevent it from entering the back stage processing unit.

### BACKGROUND OF THE INVENTION

1. Field of the Invention

The invention relates to an electronic device and, more particularly, to an electronic device for supporting a multimedia over coax alliance (MoCA) standard.

2. Description of the Related Art

The Ethernet cabling has been the dominant wiring solution in digital homes. The Ethernet cabling may be used to transfer audio, video, and digital data among different rooms at homes, and it may even connect all facilities from whole-house audio systems to home automation and security systems. However, since installation of the Ethernet cabling in a constructed building requires opening up walls, Ethernet is not an ideal choice.

Therefore, engineers at some of the world's leading technology companies are backing two new ways to build a digital home infrastructure. They mainly use wiring existed in every home to put forward the solution. For example, electrical wiring or coaxial cables existed in both a new building and an old building are utilized.

According to the difference of the selected transmitting media, the new digital home connection technique mainly includes two techniques, a HomePlug AV and a multimedia over coax alliance (MoCA). The two techniques are established and popularized by two different technique organizations, a homeplug powerline alliance and a multimedia over coax alliance, respectively.

The MoCA standard can provide stable high-transmission and high-quality network connections for households having various kinds of video equipment via coaxial cables, which does not affect other adopted equipment or networks. The MoCA standard mainly has the following advantages. First, a data transmission rate can greatly increase without changing arrangements and layout of the existing cable television networks. Second, the highest transmission rate in each 50 MHz channel may reach 270 Mbps, and a whole transmission rate of 15 channels may reach four Gbps. Third, original video signals are not affected, and the cable television network may exist at the same time. Fourth, quality of service is perfect, safety and reliability is high, and installation is convenient.

FIG. 1 is a schematic diagram of a conventional electronic device for supporting a MoCA standard. As shown in FIG. 1, the electronic device 1 includes an input terminal 11, a high pass filter 12, and a tuner 13. Generally speaking, a MoCA system has a high-frequency operating signal which is a MoCA high-power signal higher than 50 dBmV. However, the MoCA high-power signal may be transmitted to the input terminal 11 via coaxial cables, which seriously affects operations of the tuner 13 or an amplifier. Thus, reception of the digital television signals is affected.

### BRIEF SUMMARY OF THE INVENTION

One objective of the invention is to provide an electronic device for supporting a multimedia over coax alliance (MoCA) standard to improve the conventional technology.

The invention provides an electronic device for supporting a MoCA standard. The electronic device is adapted to be coupled with a coaxial cable. The electronic device includes an input terminal, a back stage processing unit, and a band pass filter. The input terminal is used to be coupled with the coaxial cable. The band pass filter is coupled between the input terminal and the back stage processing unit, and it receives an input signal via the input terminal. The input signal includes a plurality of television channel signals and a MoCA standard system signal. The band pass filter allows the television channel signals in a predetermined frequency range to pass through and transmits them to the back stage processing unit to be processed. The band pass filter also rejects a MoCA standard system signal to prevent it from entering the back stage processing unit. The width of the predetermined frequency range is at least 917 MHz, and the frequency of the MoCA standard system signal is between 1125 MHz and 1500 MHz.

One beneficial effect of the invention is that the electronic device in the invention can allow the television channel signals in the predetermined frequency range to pass through and reject high-power MoCA standard system signals between 1125 MHz and 1500 MHz to pass through. Thereby, viewing quality of the television channel signals can be improved.

These and other features, aspects, and advantages of the present invention will become better understood with regard to the following description, appended claims, and accompanying drawings.

### BRIEF DESCRIPTION OF THE DRAWINGS

FIG. 1 is a functional block diagram of a conventional electronic device for supporting a multimedia over coax alliance (MoCA) standard.

FIG. 2 is a functional block diagram of an electronic device for supporting a MoCA standard according to an embodiment of the invention.

FIG. 3 is a functional block diagram of an electronic device for supporting a MoCA standard according to another embodiment of the invention.

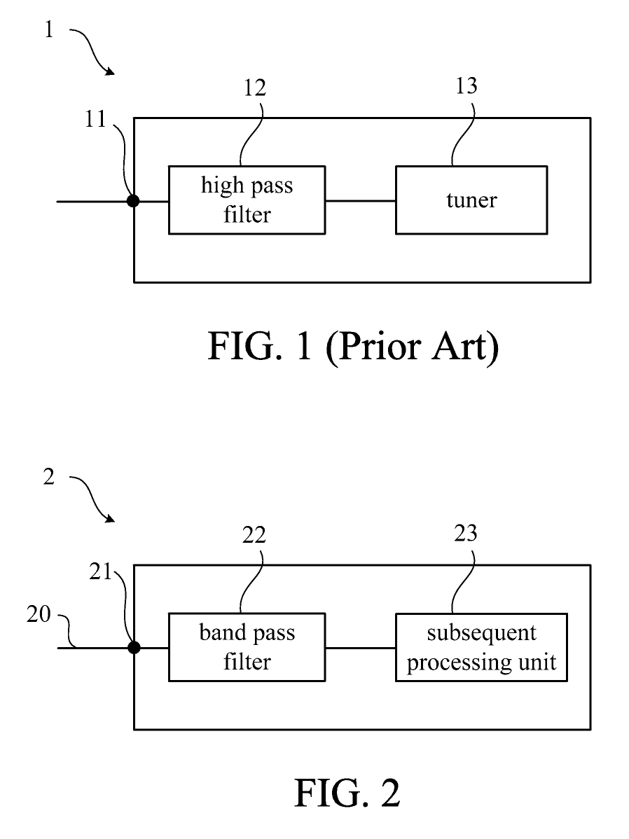

### DETAILED DESCRIPTION OF THE EMBODIMENTS

FIG. 2 is a functional block diagram of an electronic device for supporting a MoCA standard according to an embodiment of the invention. In the embodiment, an electronic device 2 may be a digital television set-top box or a cable modem. The electronic device 2 can be coupled with a coaxial cable 20 to receive multimedia information sent from a remote system via the coaxial cable 20. The multimedia information may include digital television signals, audio signals, network data, and so on.

As shown in FIG. 2, the electronic device 2 in the embodiment includes an input terminal 21, a band pass filter 22, and a back stage processing unit 23. The input terminal 21 is coupled with the coaxial cable 20, and the band pass filter 22 is coupled between the input terminal 21 and the back stage processing unit 23. The back stage processing unit 23 is a back stage of the band pass filter 22.

In the embodiment, the input terminal 21 is a coaxial cable connector for connecting the coaxial cable 20. In the embodiment, the back stage processing unit 23 is an amplifier. In other embodiments, the back stage processing unit 23 may be a tuner or another electronic device which is used to receive cable television signals or digital television signals.

In the embodiment, the band pass filter 22 is used to allow signals in a predetermined frequency range to pass through the band pass filter 22. The width of the predetermined frequency range is at least 917 MHz. For example, the predetermined frequency range is from 85 MHz to 1002 MHz. In other embodiments, the predetermined frequency range may be from 54 MHz to 1002 MHz, and the predetermined frequency range can be modified by adjusting the frequency range of the band pass filter 22 according to requirements of the cable system.

The band pass filter 22 receives an input signal from the input terminal 21, and the input signal includes a plurality of television channel signals and a multimedia over coax alliance (MoCA) standard system signal. In the embodiment, the power of the MoCA standard system signal is 50 dBmV, and the frequency of the MoCA standard system signal is between 1125 MHz and 1500 MHz. The power of every television channel signal is 15 dBmV, and the frequency of the television signal of every channel distributes between 54 MHz and 860 MHz.

In the embodiment, the band pass filter 22 has a characteristic, that is, wide bandwidth signals can pass through the band pass filter 22. Therefore, a plurality of television channel signals in the predetermined frequency range may pass through the band pass filter 22 to enter the back stage processing unit 23, and the signals out of the predetermined frequency range, such as high-power MoCA standard system signals between 1125 MHz and 1500 MHz, will be reject. Thereby, the back stage processing unit 23 such as an amplifier does not receive the high-power MoCA standard system signals and then does not distort signals.

For example, an amplifier amplifies the 15 dBmV television channel signals. If the amplifier receives 50 dBmV high-power MoCA standard system signals and amplifies them, the television channel signals may be distorted. Thus, a back stage processing of the electronic device 2 is affected. In the embodiment, the band pass filter 22 can solve the above problem. The back stage processing unit 23 such as an amplifier can operate normally.

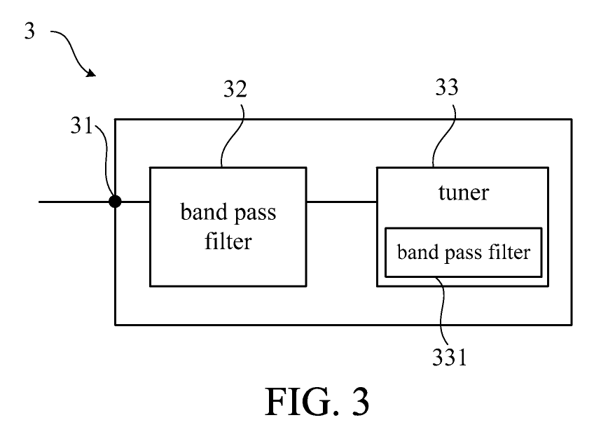

FIG. 3 is a functional block diagram of an electronic device for supporting a MoCA standard according to another embodiment of the invention. An electronic device 3 in the embodiment includes an input terminal 31, a band pass filter 32, and a tuner 33. The elements of the embodiment are similar with the elements of the above embodiment. Therefore, the connection relationship and fundamental functions of the elements are not described repeatedly.

In the embodiment, the tuner 33 is a back stage processing unit of the band pass filter 32. The tuner 33 further includes a band pass filter 331. The band pass filter 32 allows a plurality of television channel signals to pass through and transmits them to the tuner 33. The band pass filter 331 in the tuner 33 can be used to select one of the digital television channel signals. Thereby, the tuner 33 processes the selected digital television channel signal.

To sum up, the electronic device in the embodiment of the invention can allow a plurality of digital television channel signals in the predetermined frequency range to pass through and reject a MoCA standard system signal to pass through at the same time, which may prevent the MoCA standard system signal from interfering with the digital television channel signals. Thus, transmitting quality of the television channel signals on a cable increases.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An electronic device for supporting a multimedia over coax alliance (MoCA) standard, coupled with a coaxial cable, the electronic device comprising:
an input terminal coupled with the coaxial cable;
a back stage processing unit; and
a band pass filter coupled with the input terminal and the back stage processing unit, the band pass filter receiving an input signal from the input terminal, the input signal including a plurality of television channel signals and a MoCA standard system signal, wherein the band pass filter allows the television channel signals in a predetermined frequency range to pass through and transmit them to the back stage processing unit to be processed, and the band pass filter rejects the MoCA standard system signal to prevent it from entering the back stage processing unit;
wherein a width of the predetermined frequency range is at least 917 MHz, and the frequency of the MoCA standard system signal is between 1125 MHz and 1500 MHz.

2. The electronic device according to claim 1, wherein the predetermined frequency range is from 54 MHz to 1002 MHz or from 85 MHz to 1002 MHz.

3. The electronic device according to claim 1, wherein the number of the television channel signals is thirteen.

4. The electronic device according to claim 1, wherein the back stage processing unit is a tuner or an amplifier.

5. The electronic device according to claim 4, wherein the back stage processing unit is the tuner, which further comprises a band pass filter for selecting one of the television channel signals, so that the tuner processes the selected television channel signal.

6. The electronic device according to claim 1, wherein the electronic device is a digital television set-top box or a cable modem.
